(19) United States
(12) Patent Application Publication
(10) Pub. No.: US 2026/0369632 A1
(43) Pub. Date: Nov. 19, 2026

(54) BIPOLAR PLATE, METHOD FOR PRODUCING A BIPOLAR PLATE, CELL AND ELECTROCHEMICAL ENERGY CONVERTER

(71) Applicant: Robert Bosch GmbH, Stuttgart (DE)

(72) Inventor: Bernhard Mandl, Puchenau (AT)

(21) Appl. No.: 19/133,903

(22) PCT Filed: Oct. 31, 2023
(86) PCT No.: PCT/EP2023/080301

§ 371 Date: Jun. 30, 2025

(30) Foreign Application Priority Data
Dec. 1, 2022 (DE) 10 2022 212 973.3

(51) Int. Cl. H01M 8/026; H01M 8/0228

(52) U.S. Cl. CPC H01M 8/026; H01M 8/0228

(57) ABSTRACT

The invention relates to a bipolar plate (10) for a cell (11) of an electrochemical energy converter (12), with a first flow structure (13) and with a second flow structure (14) adjacent to the first flow structure (13), wherein the first and second flow structures (14) are arranged on one side of the bipolar plate (10), wherein the first flow structure (13) is designed to distribute a medium along a first longitudinal direction (X1) of the bipolar plate (10) and, wherein the second flow structure (14) is designed to distribute the medium coming from the first flow structure (13) in a second longitudinal direction (X2) and/or a transverse direction (Y) of the bipolar plate (10).

### BACKGROUND

The invention relates to a bipolar plate, a method, a cell and an electrochemical energy converter with the features of the disclosure.

In the currently known cells for electrolyzers or fuel cells, porous transport layers are used on both the anode side and the cathode side to distribute the media from the bipolar plate to the electrolyte present in each case. As the name suggests, these are made of porous materials, which means that the flow path of the medium through them often cannot be precisely determined. They are also complex to manufacture and expensive due to the materials used. Due to the porosity, the surface to be coated with a catalyst can often not be precisely determined and also not completely coated. In addition, the porous structure means that contact with a component coated with a catalyst cannot be determined precisely. This has a negative effect on the functionality.

### SUMMARY

Features and details of the invention arise from the description, and the drawings. The features and details described in connection with the bipolar plate according to the invention also apply, of course, in connection with the method according to the invention and/or in connection with the cell according to the invention and/or in connection with the electrochemical energy converter according to the invention and vice versa, so that mutual reference can always be made to the disclosure relating to the individual aspects of the invention.

According to the invention, a bipolar plate is provided for a cell of an electrochemical energy converter, with a first flow structure and with a second flow structure adjacent to the first flow structure, wherein the first and the second flow structure are arranged on one side of the bipolar plate, wherein the first flow structure is designed to distribute a medium along a first longitudinal direction of the bipolar plate and wherein the second flow structure is designed to distribute the medium coming from the first flow structure in a second longitudinal direction and/or a transverse direction of the bipolar plate.

The chemical reactions carried out in an electrochemical energy converter will take place along the first, but above all along the second flow structure. The medium is guided or distributed to the electrolyte through the distribution in the second longitudinal direction and the transverse direction. Due to this design, the porous transport layer, i.e. the gas diffusion layer, can be dispensed with when this bipolar plate is used in a cell. This primarily saves space, but also money and time when assembling a cell for an electrochemical energy converter.

When designing and arranging the first flow structure in relation to the second flow structure, it is advantageous if they are designed and assigned to each other in such a way that the direction of the medium must change. It is particularly advantageous if as many edges and/or surfaces of the second flow structure as possible are in contact with the electrolyte. This leads to an optimal reaction or formation of the reactants.

A bipolar plate according to the invention can be a separator plate or an end plate of a cell.

This simplified design allows the bipolar plate, and in particular the first flow structure and the second flow structure, to be adapted depending on the shape and/or type of electrolyte. In the installed state or in an assembled cell, the electrolyte and the second flow structure are in contact with each other. The bipolar plate is suitable for use as a cathode and/or anode.

The bipolar plate functions particularly well if it is made of a metal, in particular titanium and/or nickel and/or precious metals and/or stainless steel (e.g. 1.4404) and/or a metal with a chemically stable protective layer and/or electrically conductive plastics and/or electrically conductive ceramics.

In the context of the invention, it may be advantageous for the first flow structure and the second flow structure to be manufactured in one piece, in particular monolithically.

A one-piece bipolar plate is easy to handle and allows the first flow structure and the second flow structure to be precisely matched to each other.

The first flow structure and the second flow structure can be connected to each other in the manufacturing process. Preferably, the bipolar plate is manufactured monolithically.

In the context of the invention, it is conceivable that the first flow structure has a first number of channels and/or grooves and/or elevations and/or pores for distributing the medium in the first longitudinal direction and that the second flow structure has a second number of channels and/or grooves and/or elevations and/or pores for distributing the medium in the second longitudinal direction and/or the transverse direction.

The type of the first flow structure and the second flow structure determines the velocity of the medium when it flows through them. The first and second flow structures must be arranged relative to each other in such a way that the medium must change direction during the transition from the first flow structure to the second flow structure. Accordingly, the channels and/or grooves and/or elevations and/or pores of the respective flow structure can be combined with each other as desired. Equipping the first and second flow structures with channels and/or grooves and/or elevations and/or pores generates a flow of the medium through the bipolar plate in such a way that a porous transport layer is no longer necessary.

It is advantageous if the second flow structure is arranged at an angle of 10° to 170°, preferably 30° to 150°, more preferably 45° to 135°, to the first flow structure.

It is conceivable that the flow structures may be straight, wavy or inclined in relation to a surface. For example, the second flow structure can have an undulating course of channels and/or grooves and run diagonally across a surface spanned by the first flow structure.

Within the scope of the invention, it may be provided that the ratio of the first number to the second number is 1:1 to 5, preferably 1:1.5 to 4.4, more preferably 1:1.75 to 4.

Tests have shown that it is particularly advantageous if the first number of the first flow structure differs from the second number of the second flow structure. It is particularly advantageous if the first number of the first flow structure is smaller than the second number of the second flow structure. The higher the second number of the second flow structure, the more edges are in contact with the electrolyte when assembled, so that the reaction is optimized because it can be carried out optimally at these edges.

It would also be conceivable here if the second number of the second flow structure results from a bifurcation of the first number of the first flow structure. It is conceivable that there are further bifurcations, i.e., branches, within the second flow structure to ensure a broad distribution of the medium.

It is also conceivable that the second flow structure has a catalyst layer on a side facing away from the first flow structure.

The catalyst layer leads to an improved reaction within a cell in an electrochemical energy converter.

By applying the catalyst material as a catalyst layer to a predictable surface, the amount of catalyst material can be determined in advance. Furthermore, the specified area to be coated allows for savings in catalyst material, which in turn reduces costs.

Since the amount of catalyst material can be reduced and its application optimized, it is conceivable to use purer materials and thinner layers as the catalyst layer. The use of purer materials has a positive effect on the efficiency and functionality of the entire electrochemical energy converter. The catalyst material of the catalyst layer may be a platinum metal or an alloyed platinum metal or a platinum metal alloyed with less noble metals. Platinum metals or platinoids are the elements of groups 8 to 10 of the 5th period (the “light platinum metals”: ruthenium, rhodium, palladium) and the elements of groups 8 to 10 of the 6th period (the “heavy platinum metals”: osmium, iridium, platinum).

The catalyst layer can have a layer thickness of less than 100 μm, preferably less than 1000 nm, and more preferably less than 100 nm.

It is particularly advantageous if the catalyst layer is integrated so as to form one piece and firmly attached to the second flow structure.

According to a second aspect of the invention, a method according to the invention for manufacturing a bipolar plate as described above for a cell of an electrochemical energy converter is claimed, comprising the following steps:

providing a base material of the bipolar plate,

generating the first flow structure from the base material, and

generating the second flow structure adjacent to the first flow structure, wherein the second flow structure is/will be connected to the first flow structure.

For example, the bipolar plate may be

laser milling of the entire bipolar plate or individual elements, in particular the first and second flow structures, and/or

forming of the base material of the bipolar plate and/or

3D printing and/or

sintering and/or

casting and/or

welding or bonding of individual elements, for example the first and second flow structures, and/or

The starting material is either stamped and/or drawn into the prefabricated outer geometry or rolled from a sheet metal roll and/or manufactured.

This allows the bipolar plate to be manufactured according to the requirements of its design. The manufacturing process can therefore be adapted to the design, the material, and/or the desired costs.

The bipolar plate can then be cleaned by sputtering, in particular ion beam sputtering, or reactive ion etching or chemical cleaning or pickling or a chemical bath, or a chemical bath with ultrasound.

It is also conceivable that a catalyst layer is applied to one of the sides of the second flow structure facing away from the first flow structure.

The catalyst layer leads to an improved reaction within a cell in an electrochemical energy converter.

By applying the catalyst material as a catalyst layer to a predictable surface, the amount of catalyst material can be determined in advance. Furthermore, the specified area to be coated allows for savings in catalyst material, which in turn reduces costs.

Since the amount of catalyst material can be reduced and its application optimized, it is conceivable to use purer materials and thinner layers as the catalyst layer. The use of purer materials has a positive effect on the efficiency and functionality of the entire electrochemical energy converter. The catalyst material of the catalyst layer can comprise a platinum metal or an alloyed platinum metal or a platinum metal alloyed with base metals or a platinum group metal doped with one or more elements of the periodic table of elements. Platinum metals or platinoids are the elements of groups 8 to 10 of the 5th period (the “light platinum metals”: ruthenium, rhodium, palladium) and the elements of groups 8 to 10 of the 6th period (the “heavy platinum metals”: osmium, iridium, platinum).

Within the scope of the invention, it is optionally possible for the catalyst layer to be applied to the second side of the second flow structure by means of physical vapor deposition, chemical vapor deposition, atomic layer deposition, spray coating, electrochemical coating or plasma spray coating.

This enables precise application of the catalyst layer, so that the quantity can also be reduced.

According to a third aspect of the invention, the invention discloses an energy converter with an anode side, wherein the anode side has a first bipolar plate as described above and/or as produced above, and

with a cathode side, wherein the cathode side has a second bipolar plate as described above and/or manufactured as described above, and with an electrolyte, wherein the electrolyte is arranged between the second flow structure of the first bipolar plate and the second flow structure of the second bipolar plate.

Accordingly, the electrolyte is arranged between the second flow structure of the first bipolar plate and the second flow structure of the second bipolar plate in such a way that, during operation of the cell, the reactants can move back and forth between the anode side and the cathode side. The electrolyte can be a proton exchange membrane (PEM) or an anion exchange membrane (AEM), for example.

Since the porous transport layer is omitted in the cells or bipolar plates, the cells are smaller in size but still have high energy efficiency.

Furthermore, the invention may provide that the second flow structure has a first catalyst layer on a side facing away from the first flow structure of the first bipolar plate and that the second flow structure has a second catalyst layer on a side facing away from the first flow structure of the second bipolar plate, wherein the electrolyte is arranged between the first catalyst layer and the second catalyst layer.

The catalyst layer leads to an improved reaction within a cell in an electrochemical energy converter.

With respect to the present invention, it is conceivable that the material of the first catalyst layer and the second catalyst layer are the same or different.

Due to the reduced thickness and the direct application of the catalyst layer to the second flow structure, purer materials can be used. The catalyst material of the catalyst layer can comprise a platinum metal or an alloyed platinum metal or a platinum metal alloyed with base metals or a platinum group metal doped with one or more elements of the periodic table of elements. Platinum metals or platinoids are the elements of groups 8 to 10 of the 5th period (the “light platinum metals”: ruthenium, rhodium, palladium) and the elements of groups 8 to 10 of the 6th period (the “heavy platinum metals”: osmium, iridium, platinum).

According to a fourth aspect of the invention, the invention relates to an electrochemical energy converter according to the invention comprising a plurality of cells as described above.

This results in an efficient electrochemical energy converter.

### BRIEF DESCRIPTION OF THE DRAWINGS

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination. The invention is illustrated in the following drawings:

FIG. 1 a schematic illustration of a first exemplary embodiment of a bipolar plate according to the invention,

FIG. 2 a schematic illustration of a second exemplary embodiment of a bipolar plate according to the invention,

FIG. 3 a schematic illustration of a method for manufacturing a bipolar plate according to the invention,

FIG. 4 a schematic illustration of a cell for an electrochemical energy converter with a bipolar plate according to the invention,

FIG. 5 a schematic illustration of an electrochemical energy converter.

### DETAILED DESCRIPTION

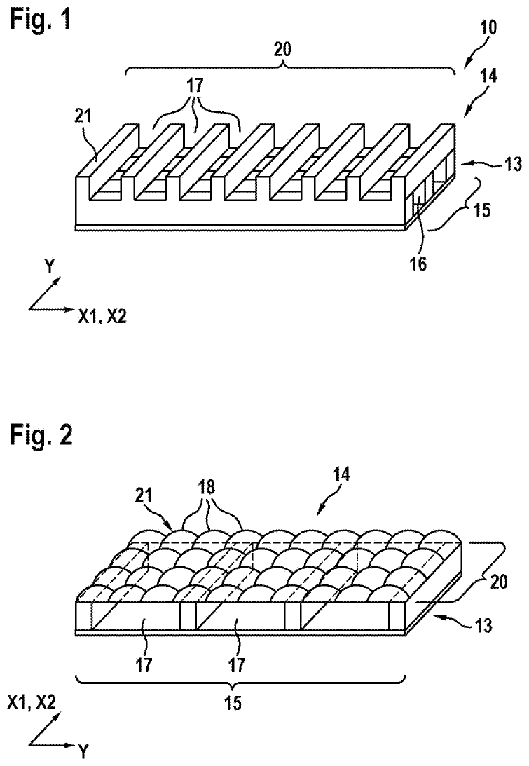

FIG. 1 and FIG. 2 show a bipolar plate 10 for a cell 11 of an electrochemical energy converter 12. The bipolar plate 10 is equipped with a first flow structure 13 and a second flow structure 14 adjacent to the first flow structure 13. The first flow structure 13 and the second flow structure 14 are arranged on one side of the bipolar plate 10. The first flow structure 13 is designed to distribute a medium along a first longitudinal direction X1 of the bipolar plate 10, and the second flow structure 14 is designed to distribute the medium coming from the first flow structure 13 in a second longitudinal direction X2 and/or a transverse direction Y of the bipolar plate 10.

In the bipolar plates 10 according to FIG. 1 and FIG. 2, the first flow structure 13 and the second flow structure 14 are integrated so as to form one piece. This means that the first flow structure 13 and the second flow structure 14 were connected to each other during the manufacturing process, as shown in FIG. 1, or they were manufactured monolithically, as shown in FIG. 2.

In FIG. 1, the first flow structure 13 of the bipolar plate 10 has a first number 15 of channels 16. The second flow structure 14 of the bipolar plate 10 has a second number 20 of grooves 17. Grooves 17 are significantly narrower in hydraulic cross-section than channels 16 and can have lower side walls.

In FIG. 2, the first flow structure 13 has a first number 15 of grooves 17 and the second flow structure 14 has elevations 18 which run obliquely, i.e. at an angle between 45° and 135° to the first flow structure 13.

Both the arrangements of the structures of the first flow structure 13 and second flow structure 14 according to the first exemplary embodiment of FIG. 1 and the arrangements of the structures of the first flow structure 13 and second flow structure 14 according to the second exemplary embodiment FIG. 2 serve to distribute the medium in the second longitudinal direction X2 and/or the transverse direction Y.

In both FIG. 1 and FIG. 2, the ratio of the first number 15 to the second number 20 is 1:1 to 5, preferably 1:1.5 to 4.4, and more preferably 1:1.75 to 4.

The second flow structure 14 has a catalyst layer 21 on a side facing away from the first flow structure 13. In FIG. 1, this catalyst layer 21 is a platinum metal, and in FIG. 2, the catalyst layer 21 is an alloyed platinum metal.

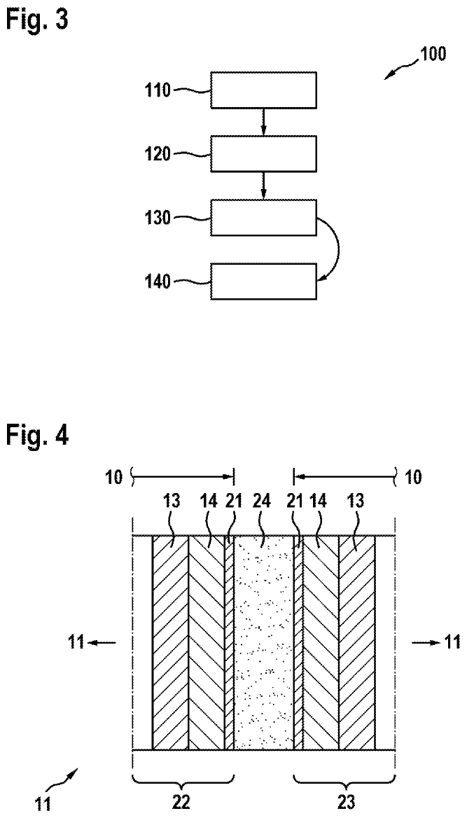

FIG. 3 shows a method 100 for manufacturing a bipolar plate 10 for a cell 11 of an electrochemical energy converter 12 according to FIG. 1 or FIG. 2, comprising the following steps of:

providing 110 a base material of the bipolar plate 10,

generating 120 the first flow structure 13 from the base material, and

generating 130 the second flow structure 14 adjacent to the first flow structure 13, wherein the second flow structure 14 is/is connected to the first flow structure 13.

In an additional step, a catalyst layer 21 is applied 140 to a side of the second flow structure 14 facing away from the first flow structure 13.

The catalyst layer 21 can be applied 140 to the second side of the second flow structure 14 by means of physical vapor deposition (PVD), chemical vapor deposition (CVD), atomic layer deposition (ALD), spray coating, electrochemical coating, or plasma spray coating. In the exemplary embodiment according to FIG. 1, the catalyst layer 21 was applied by physical vapor deposition PVD, and in the exemplary embodiment according to FIG. 2, the catalyst layer 21 was applied by spray coating.

FIG. 4 shows a cell 11 for an electrochemical energy converter 12. The cell 11 has an anode side 22, wherein the anode side 22 has a first bipolar plate 10, for example according to one of FIG. 1 or 2 and/or manufactured according to a method 100 according to FIG. 3, and a cathode side 23, wherein the cathode side 23 has a first bipolar plate 10, for example according to one of FIG. 1 or 2 and/or manufactured according to a method 100 according to FIG. 3, and with an electrolyte 24, wherein the electrolyte 24 is arranged between the second flow structure 14 of the first bipolar plate 10 and the second flow structure 14 of the second bipolar plate 10.

For a better understanding, the flow structures of the bipolar plates 10 of the cell 11 are only schematically illustrated in FIG. 4. Here, as described, the flow structures as described above can be used and combined with one another.

For improved function, the second flow structure 14 has a first catalyst layer 21 on a side facing away from the first flow structure 13 of the first bipolar plate 10, and the second flow structure 14 has a second catalyst layer 21 on a side facing away from the first flow structure 13 of the second bipolar plate 10, wherein the electrolyte 24 is arranged between the first catalyst layer 21 and the second catalyst layer 21.

In the present exemplary embodiment, the materials of the first catalyst layer 21 and the second catalyst layer 21 are the same. However, it is conceivable that the materials of the first and second catalyst layers 21 are different. The material of the catalyst layer 21 can be selected depending on the location of the material, i.e., whether it is used on the anode side 22 or the cathode side 23.

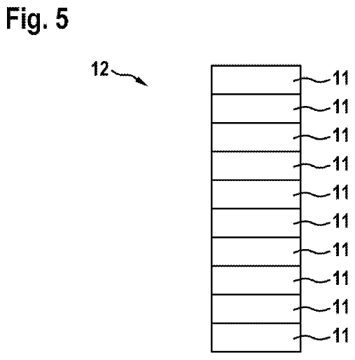

FIG. 5 shows an electrochemical energy converter 12 with a plurality of cells 11 according to FIG. 4.

1. A bipolar plate (10) for a cell (11) of an electrochemical energy converter (12), the bipolar plate (10) comprising:
a first flow structure (13) and a second flow structure (14) adjacent to the first flow structure (13), wherein the first and second flow structures (14) are arranged on one side of the bipolar plate (10),
wherein the first flow structure (13) is configured to distribute a medium along a first longitudinal direction (X1) of the bipolar plate (10) and,
wherein the second flow structure (14) is configured to distribute the medium coming from the first flow structure (13) in a second longitudinal direction (X2) and/or a transverse direction (Y) of the bipolar plate (10).

2. The bipolar plate (10) according to claim 1,
wherein
the first flow structure (13) and the second flow structure (14) are manufactured in one piece.

3. The bipolar plate (10) according to claim 1,
wherein
the first flow structure (13) has a first number (15) of channels (16) and/or grooves (17) and/or elevations (18) and/or pores for distributing the medium in the first longitudinal direction (X1), and wherein the second flow structure (14) has a second number (20) of channels (16) and/or grooves (17) and/or elevations (18) and/or pores for distributing the medium in the second longitudinal direction (X2) and/or the transverse direction (Y).

4. The bipolar plate (10) according to claim 3,
wherein
a ratio of the first number (15) to the second number (20) is 1:1 to 5.

5. The bipolar plate (10) according to claim 1,
wherein
the second flow structure (14) has a catalyst layer (21) on a side facing away from the first flow structure (13).

6. A method (100) for manufacturing a bipolar plate (10) for a cell (11) of an electrochemical energy converter (12) according to claim 1, comprising the following steps of:
providing (110) a base material of the bipolar plate (10),
generating (120) the first flow structure (13) from the base material, and
generating (130) the second flow structure (14) adjacent to the first flow structure (13), wherein the second flow structure (14) is/will be connected to the first flow structure (13).

7. The method (100) according to claim 6,
wherein
a catalyst layer (21) is applied (140) to a side of the second flow structure (14) facing away from the first flow structure (13).

8. The method (100) according to claim 7,
wherein
the catalyst layer (21) is applied (140) to the side of the second flow structure (14) by physical vapor deposition (PVD), chemical vapor deposition (CVD), atomic layer deposition (ALD), spray coating, electrochemical coating, or plasma spray coating.

9. A cell (11) for an electrochemical energy converter, having an anode side (22), wherein the anode side (22) comprises a first bipolar plate (10), and
having a cathode side (23), wherein the cathode side (23) comprises a second bipolar plate (10), and
having an electrolyte (24), wherein the electrolyte (24) is arranged between the first flow structure (13) of the first bipolar plate (10) and the second flow structure (14) of the second bipolar plate (10),
wherein each of the first and second bipolar plates (10) are according to claim 1.

10. The cell (11) according to claim 9,
wherein
the second flow structure (14) has a first catalyst layer (21) on a side facing away from the first flow structure (13) of the first bipolar plate (10), and the second flow structure (14) has a second catalyst layer (21) on a side facing away from the first flow structure (13) of the second bipolar plate (10), wherein the electrolyte (24) is arranged between the first catalyst layer (21) and the second catalyst layer (21).

11. The cell (11) according to claim 10,
wherein
the material of the first catalyst layer (21) and the second catalyst layer (21) is the same.

12. An electrochemical energy converter comprising a plurality of cells (11) according to claim 9.

13. The bipolar plate (10) according to claim 4, wherein the ratio of the first number (15) to the second number (20) is 1:1.5 to 4.4.

14. The bipolar plate (10) according to claim 13, wherein the ratio of the first number (15) to the second number (20) is 1:1.75 to 4.

15. The cell (11) according to claim 10, wherein the material of the first catalyst layer (21) and the second catalyst layer (21) is different.
